(19) United States
(12) Patent Application Publication
(10) Pub. No.: US 2025/0231275 A1
(43) Pub. Date: Jul. 17, 2025

(54) RADAR SENSOR AND WAVEGUIDE SEPARATION

(71) Applicant: VEGA Grieshaber KG, Wolfach (DE)

(72) Inventors: Klaus KIENZLE, Zell am Harmersbach (DE); Fritz LENK, Schiltach (DE)

(73) Assignee: VEGA Grieshaber KG, Wolfach (DE)

(21) Appl. No.: 19/008,440

(22) Filed: Jan. 2, 2025

(30) Foreign Application Priority Data
Jan. 11, 2024 (EP) 24151425.6

(51) Int. Cl. G01S 7/03; H01P 1/213

(52) U.S. Cl. CPC G01S 7/032; H01P 1/2131

(57) ABSTRACT

A radar sensor is provided, including: a waveguide including a waveguide inner wall, a first portion, and a second portion separate from the first portion; and a waveguide separator configured to separate the first section from the second section, the waveguide separator being an element including a first component and a second component of different material than the first component.

### CROSS-REFERENCE TO RELATED APPLICATIONS

This application claims the benefit of priority under 35 U.S.C. § 119 from European Patent Application No. 24 151 425.6 filed on 11 Jan. 2024, the entire content of which is incorporated herein by reference.

### TECHNICAL FIELD

The invention relates to a radar sensor, a waveguide separation, and a use of the waveguide separation.

### BACKGROUND

In radar sensors, for example for level measurement of liquids and bulk materials for monitoring industrial processes, electromagnetic waves generated by an RF chip are coupled into a waveguide, which is expanded into a horn radiator, for example, in order to radiate the conducted wave in the waveguide as a spatial wave or to serve as an antenna feed. If an electrical isolation is inserted during coupling, the waves escape from the waveguide. They propagate along, e.g., housing parts or other structures and are reflected. The resulting different propagation times cause interference with the waves in the waveguide. Absorbers are used to avoid this. The radar sensor can be designed in such a way that the absorber can be inserted into the radar sensor inside the sensor housing. Logistical, mechanical and, with regard to the sensor, manufacturing effort is required to provide the absorber, install it in the sensor and hold it in its specific position. Grooves for seals must be made in such a way that they do not impair the function of the absorber.

There may be a desire to provide an improved radar sensor.

### SUMMARY

The desire is met by the subject-matter of the independent patent claims. Advantageous embodiments are the subject of the dependent claims, the following description and the figures.

According to a first aspect, there is provided a radar sensor comprising a waveguide having a waveguide inner wall, a first portion and a second portion separated from the first portion. The waveguide further comprises a waveguide separator for separating the first section from the second section, wherein the waveguide separator is an element comprising a first component and a second component of different material.

### BRIEF DESCRIPTION OF THE DRAWINGS

In the following, embodiments of the invention are explained in more detail with reference to the schematic drawings.

FIG. 1 shows a schematic diagram of a first separator made of a first material,

FIG. 2 shows a schematic diagram of the first series part and the reflection, transmission and emission of microwave energy from the waveguide into the adjacent parts,

FIG. 3 shows a diagram in which the transmission (S21) and the reflection (S11) of the first series part are plotted as a function of frequency.

FIG. 4 shows a schematic diagram of a second separator made of a second material,

FIG. 5 shows a schematic diagram of the second separator and the reflection, transmission and emission of microwave energy from the waveguide into the adjacent parts,

FIG. 6 shows a diagram in which the transmission (S21) and the reflection (S11) of the second series part are plotted as a function of frequency.

FIG. 7 shows a schematic diagram of a third separator made of a first and a second material,

FIG. 8 shows a schematic diagram of the third separator and the reflection, transmission and emission of microwave energy from the waveguide into the adjacent parts,

FIG. 9 shows a diagram in which the transmission (S21) and reflection (S11) of the third series part are plotted as a function of frequency.

FIG. 10 shows a schematic diagram of a fourth separator made of first and second material,

FIG. 11 shows a schematic diagram of the fourth separator and the reflection, transmission and emission of microwave energy from the waveguide into the adjacent parts,

FIG. 12 shows a diagram in which the transmission (S21) and the reflection (S11) of the fourth series part are plotted as a function of frequency.

FIG. 13 shows a schematic diagram of a fifth separator made of a first and a second material,

FIG. 14 shows a schematic diagram of the fifth separator and the reflection, transmission and leakage of microwave energy from the waveguide into the adjacent parts,

FIG. 15 shows a diagram in which the transmission (S21) and the reflection (S11) of the fifth series part are plotted as a function of frequency.

FIG. 16 shows sketch of a radar sensor.

### DETAILED DESCRIPTION OF EMBODIMENTS

The described embodiments similarly relate to the radar sensor, the waveguide separator and the use of the separator as a radio frequency (RF) absorbing component in a radar sensor. Synergy effects may result from various combinations of the embodiments, although they may not be described in detail.

Technical terms are used in the usual way. If certain terms are assigned a specific meaning, definitions of terms are given below, in the context of which the terms are used.

To transmit a radar signal, the waveguide conducts the high-frequency electromagnetic wave generated by an electronics unit of the radar sensor from the electronics unit to an exit point, e.g., an opening in the waveguide or an antenna. To receive a radar signal, the wave received at the opening or antenna takes the reverse path to the electronics unit. The waveguide has a separation point, which is used for potential separation, for example. The separator thus separates the waveguide into a first section, which is connected to the electronics unit that couples the wave into the waveguide, and a second section with the exit aperture, and is thus an intermediate part between the two sections.

Even if the direction of the wave from the electronics unit in the direction of the antenna, i.e., for transmission, is described by way of example in this disclosure, the embodiments are valid analogously for the reverse direction, i.e., for receiving the wave, for example at the antenna, and guiding the wave from the second section via the waveguide separator to the first section and the electronics.

The term “components” is used here to refer to parts or sections that form the separation point.

In this disclosure, formulations such as “energy emerges from the waveguide” are used. The skilled person is aware that the waveguide wave propagates in the material-free interior space defined by the inner wall of the waveguide. “Leaving the waveguide” therefore means that the energy leaves the interior of the waveguide. Similar formulations are to be understood accordingly.

According to an embodiment, the first component and the second component of different materials have different RF properties.

The different HF properties of the two components of the separating point are based on the different materials of these components.

According to an embodiment, the different RF properties relate to absorption and radio frequency conductivity.

The high-frequency conductivity is reflected, for example, in the two-port properties, whereby the two-port properties are a transmission factor and a reflection factor. Furthermore, the materials can have different electrical insulation properties.

For example, the first component is designed to provide better absorption than the second component, while the second component provides better isolation than the first component and is designed to allow the wave to pass from the first section to the second section of the waveguide with as little loss and reflection as possible. This means, for example, that the second component has a better transmission factor, e.g., the S12 parameter value of a second port, and a better reflection factor, e.g., the S11 parameter value of the second port. In the receiving direction, the S21 or S22 parameter values are correspondingly involved.

According to an embodiment, the shape of the waveguide separator is such that at least a part of the first component partially encloses the first section and the first component has better absorption properties than the second component.

The first component has a cylindrical part, for example. The inner diameter of this cylinder is equal to the diameter of the first waveguide section with the same axis of rotation. This means that the first component is not or only marginally responsible for transmitting the waveguide wave, but surrounds the waveguide for the most part in order to absorb the energy emerging from the first component. The second section of the waveguide can be designed in this cylindrical part in such a way that it surrounds the first component and thus also, separated by the cylindrical part, the first section in this area.

According to an embodiment, the shape of the separator is such that the second component at least partially continues the waveguide inner wall at the separator and the second component has better transmission and/or reflection properties than the first component.

The second component is responsible for the electrical insulation and the transmission of the waveguide wave and therefore has the favorable properties mentioned above and described below.

According to an embodiment, the second component consists of a low-loss dielectric.

“Low-loss” refers to the continuation of the wave. A so-called low-loss dielectric, i.e., a low-loss dielectric such as polypropylene (PP) or polytetrafluoroethylene (PTFE), or other materials with similar properties, i.e., insulation materials in high-frequency technology that have only low losses in the high-frequency range, are suitable for the second component.

PEEK CF30 or PTFE CA25, for example, are suitable for the first component. PEEK CF30 is a polyetheretherketone (PEEK) material filled with 30% carbon fibers, while PTFE CA25 contains 25% carbon by weight. Due to the carbon fibers and carbon, these materials have an absorbent effect and are virtually impermeable to high frequencies.

According to an embodiment, the first component is connected to the second component without a gap.

This measure reduces energy leakage and reflection and improves transmission.

According to an embodiment, the first component is connected to the second component by one or more of the following methods: bonding, threading, welding and/or pressing.

According to an embodiment, the waveguide separator is in one piece.

The separator can be manufactured using a two-component injection molding process, for example, or by turning it out of prefabricated two-component rod material. One-piece production simplifies handling and logistics and reduces the cost of manufacturing the radar sensor.

According to an embodiment, the radar sensor is a level sensor, a point level sensor, a flow sensor or a pressure sensor.

The radar sensor is used, for example, in an automation technology system, whereby the term automation technology should be interpreted broadly here and includes process automation and factory automation. The radar sensor is used, for example, in a process system for monitoring a chemical or physical process.

According to an embodiment, the radar sensor has an electronics unit with an RF component and an adapter element, the adapter element being designed in such a way that the electronics unit is located on a first side of the adapter element and the first section of the waveguide is located on an opposite second side of the adapter element, the waveguide separator resting against the adapter element.

The adapter element is used in particular for mechanical fixation or stability of the waveguide at the connection to the circuit board. The adapter element can extend radially to the housing of the radar sensor. The waveguide itself is also mechanically stabilized as the waveguide separator rests against the adapter element.

According to a further aspect, there is provided a waveguide separator which is an element comprising a first component and a second component of different material; wherein the waveguide separator is configured to galvanically separate a first portion of a waveguide from a second portion of the waveguide.

The waveguide separator is, for example, a separator for a radar sensor described here. The separator electrically isolates the electronics from the antenna, for example.

According to an embodiment, at least the material of the second component is a non-conductive material in order to effect a potential separation of the first section from the second section.

Further embodiments of the separator have already been described with regard to the radar sensor and will therefore not be repeated here.

According to a further aspect, a use of the waveguide separator described herein in a radar sensor is provided.

The separator can also be used in other waveguide devices where isolation, e.g., electrical isolation, is required.

According to an embodiment, the waveguide separator is used to isolate the potential of the waveguide.

Corresponding parts are provided with the same reference signs in all figures. The invention is explained primarily with reference to an embodiment in which the wave is directed from the electronics unit towards the antenna. However, this example does not limit the invention. The embodiments apply analogously to the opposite direction.

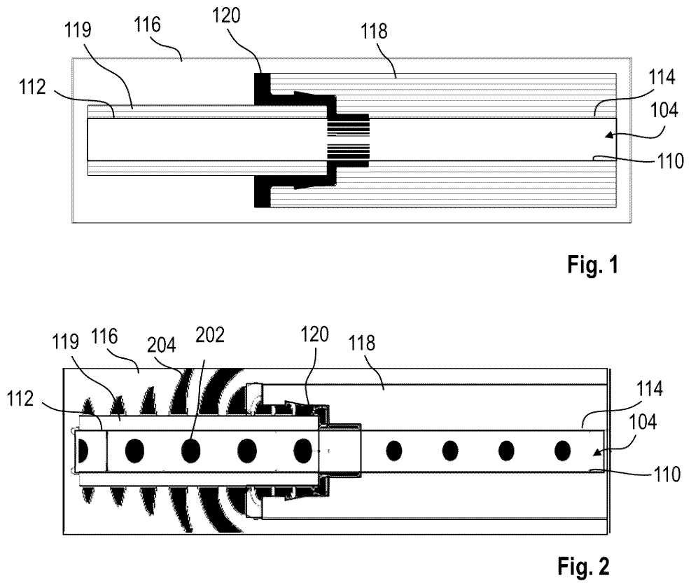

FIGS. 1-15 show variants of a schematic diagram of the waveguide arrangement with five different embodiments of a separation point, a diagram with the energy exiting from or at the separator and entering different areas of the respective waveguide arrangement, and in each case a curve diagram in which the two-port S-parameters are plotted against the frequency.

FIG. 16 shows a sketch of a radar sensor 100. The radar sensor 100 has a housing 1606 and has an electronics board with an electronics unit 1602. An RF chip 1604 mounted there feeds a high-frequency wave into the first section 112 of the waveguide 104 to transmit a radar signal. The high-frequency wave propagates via the second component 720 of the separator 700 to the second section 114 of the waveguide 104 and finally to the antenna 1608, in FIG. 16 a horn antenna 1608. When the echo signal is received, the path of the high-frequency wave is reversed accordingly. That is, the reflected wave is received at the antenna 1608 and travels via the second section 114, the second component 720 and the first section 112 of the waveguide 104 with a waveguide inner wall 110 to a receiver module on the electronic board.

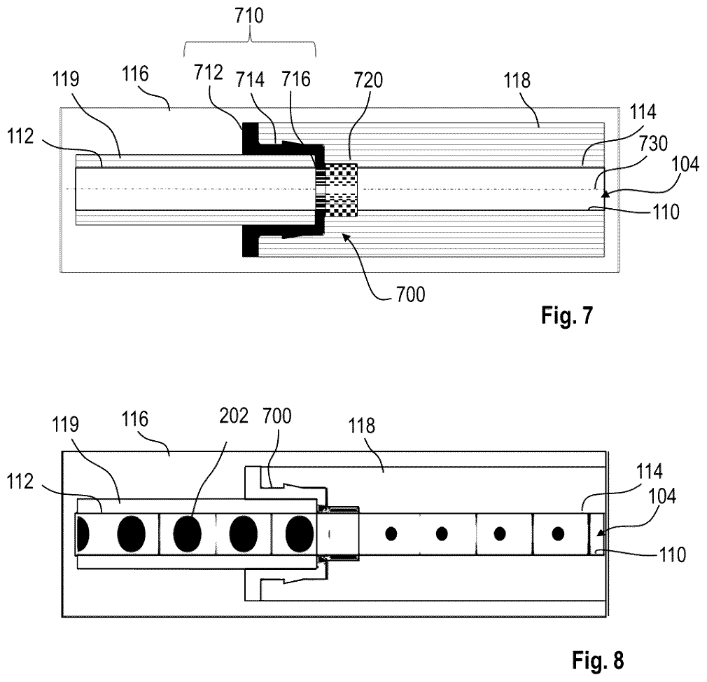

FIG. 1 shows a schematic diagram of a separator 120 of a component, which is a part for separating a first section 112 of a waveguide 104 from a second section 114. Such a separation is used, for example, for potential separation. The insulation thickness of the separation part 120 in FIGS. 1-6 and 720 in FIGS. 7-15 is dimensioned such that no short-circuit current can reach the electronics 1602 from a container, for example. The material of the separating section 120 in FIG. 1 conducts the high-frequency wave and is simultaneously absorbent. As an example, the material has the designation PTFE TFM 1600 with the parameter values dielectric constant (DK value), which is approximately 2.055, and dissipation factor (DF) tan delta, which is approximately 0.00073, measured at a frequency of 80 GHz. Depending on the material, these two values can be frequency dependent. In the figures, the separation point, in FIG. 1 the separator 120, abuts a part 1610, which can be an adapter element for the mechanical and/or electrical connection of the waveguide 104 and can be connected to the housing 102 of the radar sensor 100, so that mechanical stability is achieved. A simple structure—as shown in the sketch in FIGS. 1-15—was selected for simulations. The areas 118, 119 marked with longitudinal lines form the first section 112 or second section 114 and thus the waveguide 104, which can be a metal tube with a bore, for example. Suitable materials are, for example, silver or aluminum, but stainless steel can also be used. The area 116 is empty, or air, at least for simulation purposes. An electromagnetic waveguide wave generated by the electronic unit 1602 of the sensor 100 is fed, for example, into the first section 112 of the waveguide 104 and passes through the separator 120 into the second section 114 of the waveguide 104.

FIG. 2 shows a schematic diagram of the waveguide 104 with the first separator 120 and the reflection, transmission and emission of microwave energy occurring there from the waveguide 104 into the separation piece 700 and into the adjacent area 116. In FIG. 2, the reflection of the waveguide wave in the first section 112 at the separator 120 is recognizable. The circles 202, which represent the energy of the waveguide wave propagating in the waveguide 104, are accordingly significantly larger than those in the second section 114 of the waveguide 104. Furthermore, some of the energy escapes at the separator 120 and passes through the solid areas of the separator 120 into the area 116. The areas 204 shown in black in FIG. 2 illustratively represent the locations of high energy. The strong energy propagation into the separator 120 and into the adjacent area 116 is striking. The transitions between the locations of high and low energy are fluid, contrary to the binary black and white representation in the figures. Locations with low energy, which are present almost everywhere in the area 116 of FIG. 2, are not recognizable due to this binary representation.

It would be desirable for the energy distribution in the waveguide 104 to be the same in both sections 112, 114, i.e., for the circles in the representation to be the same size, and for the energy areas shown in black to disappear in the area 116.

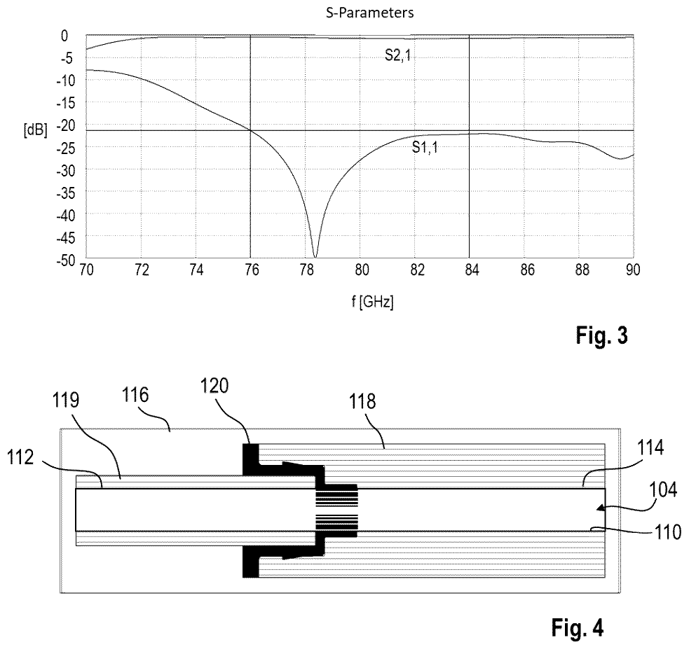

FIG. 3 shows a diagram in which the input reflection factor S11 and the forward transmission factor S21 of the first series part are plotted as a function of frequency in a frequency range from 70 GHz to 90 GHz. The transmission is constant over almost the entire frequency range. The reflection is below −21.5 dB in the range from 76 GHz to 84 GHz with a negative peak at approximately 78.2 GHz, at which the S21 value is −50 dB. At the reference frequency of 80 GHz selected in FIGS. 1-15, the S11 parameter value is −28.125 dB and the S21 parameter value is −0.765 dB.

The input reflection factor S11 is also referred to as “reflection” for short in this description, and the forward transmission factor S21 as “transmission”.

FIG. 4 shows a schematic diagram of an interface 120 made of a material labeled PEEK CF30 with the parameter values DK value 12.32 and DF value tan delta 0.525 measured at 80 GHz.

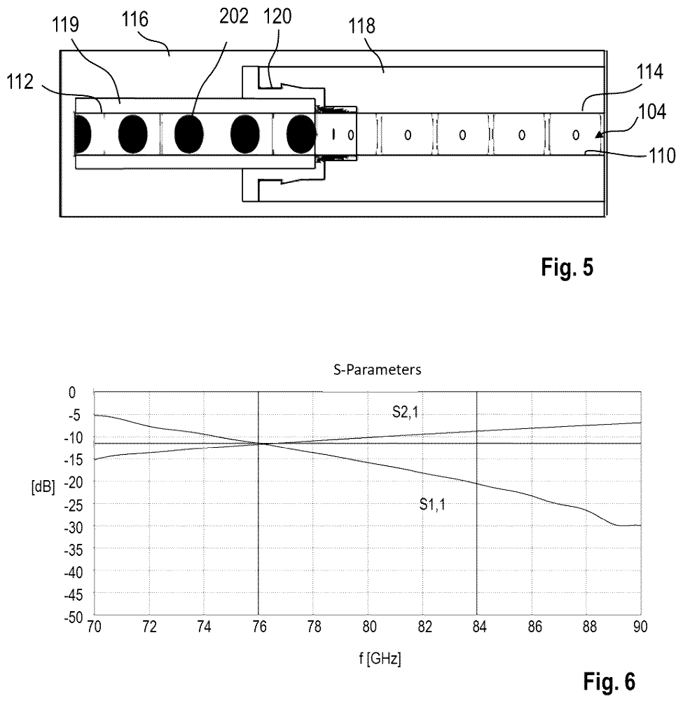

FIG. 5 shows a diagram of the separator 120 of FIG. 4 with the reflection and transmission occurring there and the emission of microwave energy from the waveguide 104 into the separation piece 700 and into the adjacent region 116. It can be clearly seen that in this case, although little microwave energy is emitted from the waveguide 104 into the adjacent parts, there is a strong absorption plus a small reflection, so that there is a weak transmission into the second section 114 of the waveguide 104.

The corresponding S-parameter diagram is shown in FIG. 6. The transmission is constant over almost the entire frequency range. The reflection is below −11.5 dB in the range from 76 GHz to 84 GHz and falls approximately linearly. At the reference frequency of 80 GHz selected in FIGS. 1-15, the S11 parameter value is −15.9 dB and the S11 parameter value is −10.2 dB. The good absorption property is therefore achieved at the cost of poor S-parameter values.

FIG. 7 shows a schematic diagram of a third separator 700. In contrast to the first and second separation points 120, the third separator 700 comprises a first component 710 made of a first material and a second component 720 made of a second material. The first component 710 is shown in solid black and the second component 710 is shown with a checkerboard pattern. The material of the first component 710 is PTFE, for example, as in the previous embodiment, and the material of the second component 720 is PEEK CF30. The first component 710 is pot-shaped with a vertically extending edge 712, wherein the axis of rotation 712 of the pot shape coincides with the axis of rotation 712 of the annular second component 720 and the axis of rotation 712 of the waveguide 104, and the side 704 of the pot shape surrounds the first portion 112 of the waveguide 104. The bottom 716 of the pot shape has a certain thickness and has a larger diameter than the waveguide inner wall 110 to form the pot shape. In addition, the bottom 716 has an opening, indicated by the white lines in the bottom 116 in the view of FIG. 7, with a diameter equal to that of the inner wall 110 of the waveguide 104. Since this component 710 directly adjoins the first section 112, the base 716 with the opening forms an extension of the first section 112 of the waveguide 104. The side 714 of the pot shape with the projecting edge 712 encloses a part of the waveguide region 119, i.e., the first section 112, and serves to electromagnetically shield the separator 700. Furthermore, the side 714 is enclosed by a part of the waveguide part 118, i.e., the second section 114. On the “top of the pot”, the projecting edge 702 is located vertically outwards, i.e., radially away from the waveguide part 119, which in FIG. 7 and the other figures forms the termination to the area 116 on one side or can come to rest against an adapter piece 1610 or another part of the sensor. On the other side, it rests against the waveguide part 118. However, the shape of the first component 710 may also differ from that shown. For example, it can also be rectangular, e.g., if the waveguide 104 is a rectangular waveguide. Furthermore, the base 716, side 714 and edge 712 do not necessarily have to be aligned perpendicular to each other. Furthermore, the side 714 may also be thicker than shown and the projecting edge 712 can be missing. Further embodiments are possible. For example, as shown in FIG. 7, the second component 720 is cylindrical and oriented toward the second portion 114 of the waveguide 104. However, it could also be arranged as a mirror image, so that it is oriented towards the first section 112 of the waveguide 104. The second component 720 also continues the waveguide inner wall 110. The first 710 and the second 720 component may be bonded, screwed or otherwise connected to each other, for example. Alternatively, the separator 700 can be formed in one piece.

FIG. 8 shows a graphic of the separator 700 as shown in FIG. 7 and the reflection, transmission and emission of microwave energy from the waveguide 104 into the separation piece 700 and into the adjacent area 116. Compared to FIG. 2, the emission of energy is low and comparable to the energy emission as in FIG. 5. The reflection is similar to that in FIG. 5, but a clear improvement in transmission can be seen.

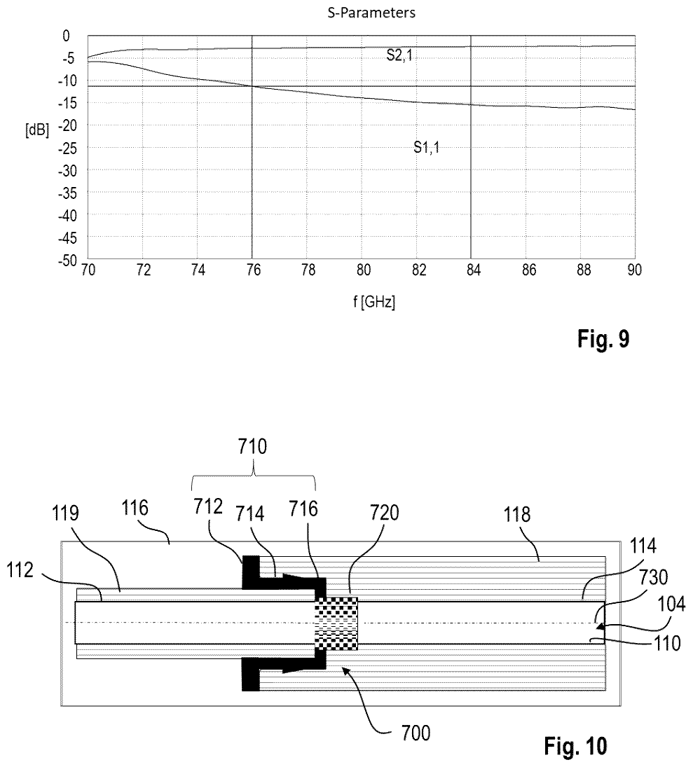

The reflection and transmission coefficients S11 and S12 of the arrangement in FIGS. 7 and 8 are plotted against the frequency in the diagram in FIG. 9. In the frequency range between 76 GHz and 80 GHz, the reflection coefficient S11 is between approximately −11 dB and −15 dB and is therefore comparable to that shown in FIG. 6. In the range up to 84 GHz, the reflection coefficient S11 is up to approximately 4 dB worse. However, the transmission coefficient is −2.5 dB and therefore significantly better than that of FIG. 6 with −10 dB+/−2 dB in the said frequency range between 76 and 84 GHz. The reference values at 80 GHz are −14 dB for the S11 parameter value and −2.6 dB for the S21 parameter value. Thus, good absorption properties with an acceptable reflection coefficient value S11 and a good transmission coefficient value S21 are achieved with the two-component separator 700 shown in FIG. 7.

In FIG. 10, a schematic diagram of a separator 700 comprising two components 710, 720 of different material is shown in an alternative embodiment. In this embodiment, the second component 720 continues the waveguide inner wall 110 alone, i.e., the second component 720 adjoins both the first section 112 of the waveguide 104 and its second section 114, and has an opening through which the wave can pass between the sections 112, 114. Similar to the embodiment according to FIG. 7, the first component 710 has a pot shape, in which the bottom 716 has an opening. However, this opening now accommodates the second component 720, so that the thickness of the remaining, outer edge of the base 716 encloses the first component 710, that is, the edge of the base at least partially encloses the first component 710. Accordingly, the first component 710 and the second component 720 preferably partially overlap along the axis of rotation 712, for example in the region adjacent the first portion 112, wherein the first component surrounds the waveguide portion 119 and the second component 710 extends towards the second portion 114 in the direction of the antenna 1608. However, the overlapping region may also be located at a different location, for example, in the center of the second component 720 or in the region adjacent to the second portion 114. The overlapping region may further cover the entire second component 720 or even extend beyond it. That is, the thickness of the edge of the base 716 may be equal to or greater than the length in the direction of the axis of rotation 730 of the second component 720. Referring to FIG. 7, the shape of the waveguide 104 and the two components 710, 720 may vary, for example in the case of a rectangular waveguide. In this case, the axis of rotation 730 would correspond to a central longitudinal axis of the rectangular waveguide. The pot shape could be described as a rectangular pot shape. The first 710 and second 720 components may be bonded, screwed or otherwise connected to each other, for example. Alternatively, the separator 700 may be integrally formed. The expression “the opening of the base accommodates the second component 114” does not mean herein that the two components are assembled during manufacture, but relates to the structure, which can also be carried out in a single manufacturing step, in particular in order to manufacture the separator in one piece.

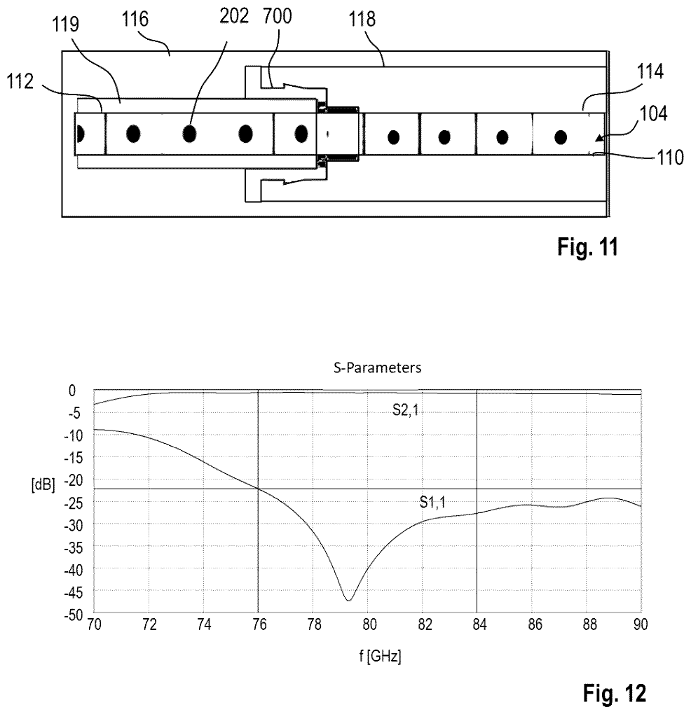

FIG. 11 shows a graph of the separator 700 according to FIG. 10 and the reflection, transmission and leakage of microwave energy occurring there from the waveguide 104 into the separation piece 700 and into the adjacent area 116. Compared to FIG. 8, the leakage of energy is approximately the same. However, significant improvements can be seen both in terms of reflection and transmission, as is also confirmed by the curve shown in FIG. 12.

The reflection and transmission coefficients S11 and S12 of the arrangement in FIGS. 10 and 11 are plotted against the frequency in the diagram in FIG. 12. The reflection coefficient S11 is below 22 dB in the frequency range between 76 GHz and 80 GHz with a negative peak at just under 80 GHz, where the S11 value is −47 dB. The transmission factor is almost consistently around −0.7 dB. The reference values at 80 GHz are −40.3 dB for the S11 parameter value and −0.7 dB for the S21 parameter value. Thus, the two-component isolation point 700 shown in FIG. 10 provides good absorption properties with a very good reflection coefficient value S11 and a very good transmission coefficient value S21, which exceed, i.e., are better than, the values for the arrangement shown in FIG. 1. Compared to the arrangement shown in FIG. 4, which also has good absorption properties, the parameter values S11 and S21 are clearly exceeded.

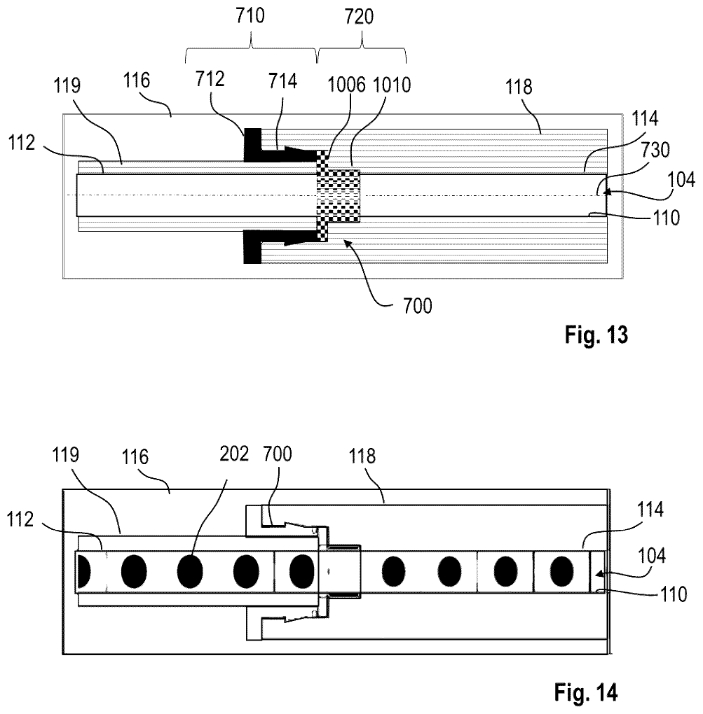

FIG. 13 shows a schematic diagram of the separator 700 comprising two components 710, 720 according to a further embodiment. In this embodiment, the base 716 of the first component 710 as shown in FIGS. 7 and 10 is made entirely of the second material. That is, the first component 710 comprises a cylinder 704 that has a protruding edge 712 at one end and is open at that end and at the opposite end towards the second portion 114 of the waveguide 104, where it is adjacent to or abuts the second component 720 at the opposite end. The second component 720 comprises a disk 1006 corresponding to the base 716 of FIGS. 7 and 10 of the first component 710, the disk 1006 being adjacent to the first component 710 on a first side and adjacent to a cylinder 1010 on a second side. The first component 710 thus completely encloses the waveguide portion 119, while the second component 710 alone continues the waveguide inner wall 110 between the first 112 and second 114 portions. In this case, variants as already described are also possible.

FIG. 14 shows a diagram of the separator 700 according to FIG. 13 and the reflection, transmission and emission of microwave energy occurring there from the waveguide 104 into the separation piece 700 and into the adjacent area 116. Compared to FIG. 11, the energy emission is similar, but both the transmission is higher and the reflection is lower, as can be seen from the approximately equal circles in the two sections of the waveguide 104.

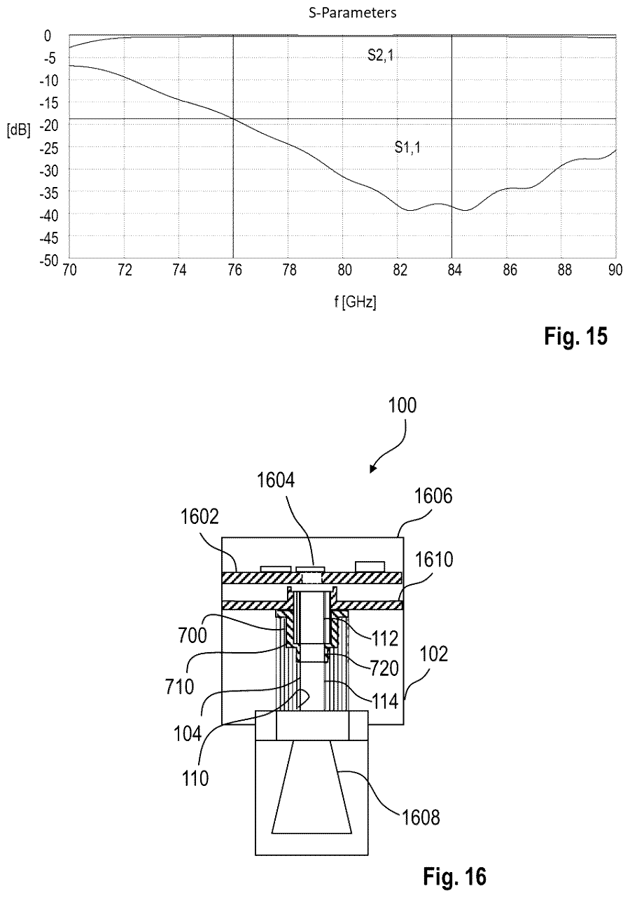

FIG. 15 shows a diagram in which the transmission (S11) and reflection (S21) of the arrangement according to FIG. 12 are plotted as a function of frequency.

Compared to FIG. 8, the energy leakage is approximately the same. However, significant improvements can be seen both in terms of reflectance and transmission, as is also confirmed by the curve shown in FIG. 12.

The reflection and transmission coefficients S11 and S12 of the arrangement in FIGS. 10 and 11 are plotted against the frequency in the diagram in FIG. 12. The reflection coefficient S11 decreases continuously to around −40 dB up to approximately 82 GHz and is below −19 dB from 76 GHz. The transmission coefficient is almost consistently around −0.3 dB. The reference values at 80 GHz are −31.7 dB for the S11 parameter value and −0.3 dB for the S21 parameter value. This means that the two-component interface 700 shown in FIG. 13 provides good absorption properties with a very good reflection factor value S11 and a very good transmission factor value S21.

Mixed forms can also be formed from the separating point designs of FIGS. 7, 10 and 13. In particular, the design selected for a sensor can depend on the frequency of the sensor. Furthermore, the frequency-dependent two-port values can be influenced by varying the dimensions of the interface or the components of the interface.

Other variations of the disclosed embodiments may be understood and carried out by one skilled in the art in practicing the claimed invention by studying the drawings, the disclosure and the appended claims. In the claims, the word “comprising” does not exclude other elements or steps, and the indefinite article “one” or “a” does not exclude a plurality. A single processor or other unit may perform the functions of multiple items or steps recited in the claims. The mere fact that certain measures are specified in interdependent claims does not mean that a combination of these measures cannot be used advantageously. Reference signs in the claims should not be construed to limit the scope of the claims.

### LIST OF REFERENCE SIGNS

100 Radar sensor
102 Housing of the radar sensor
104 Waveguide
110 Waveguide inner wall
112 First section of the waveguide
114 Second section of the waveguide
116 Area adjacent to the waveguide
118 Waveguide part forming the second section 112
119 Waveguide part forming the first section 114
120 Separator
202 High-frequency energy in the waveguide
204 Escaping high-frequency energy
700 Separator consisting of two components
710 First component of the disconnecting point
712 Protruding edge
714 Side of the pot-shaped first component, cylinder
716 Bottom of the pot-shaped first component
720 Second component of the separator, cylinder
730 Common axis of rotation of the waveguide and the separator
1006 Disc of the second component according to an embodiment
1010 Cylinder of the second component according to an embodiment
1602 Electronic unit, circuit board
1604 HF chip
1606 Housing
1608 Horn antenna
1610 Adapter element

1. A radar sensor, comprising
a waveguide comprising a waveguide inner wall, a first portion, and a second portion separate from the first portion; and
a waveguide separator configured to separate the first section from the second section, wherein the waveguide separator is an element comprising a first component and a second component of different material than the first component.

2. The radar sensor according to claim 1, wherein the first component and the second component are different materials that have different RF properties.

3. The radar sensor according to claim 2, wherein the different RF properties relate to an absorption and a radio frequency conductivity.

4. The radar sensor according to claim 1, wherein a shape of the waveguide separator is designed such that at least a part of the first component partially encloses the first portion and the first component has better absorption properties than the second component.

5. The radar sensor according to claim 1, wherein a shape of the waveguide separator is designed such that the second component at least partially continues the waveguide inner wall at the separator and the second component has a better conductivity than the first component.

6. The radar sensor according to claim 1, wherein the second component comprises a low-loss dielectric.

7. The radar sensor according to claim 1, wherein the first component is connected to the second component without a gap.

8. The radar sensor according to claim 1, wherein the first component and the second component are interconnected by one or more of the following ways: an adhesive bond, a weld, a thread, and/or a grouting.

9. The radar sensor according to claim 1, wherein the waveguide separator is integral with the radar sensor.

10. The radar sensor according to claim 1, wherein the radar sensor is a level sensor, a point level sensor, a flow sensor, or a pressure sensor.

11. The radar sensor according to claim 1,
further comprising an electronics unit with an RF component and an adapter element, wherein the adapter element is designed such that the electronics unit is located on a first side of the adapter element and the first section of the waveguide is located on an opposite second side of the adapter element, the waveguide separator abutting against the adapter element.

12. A waveguide separator, which is an element of a first component and a second component of different material than the first component, the waveguide separator being configured to galvanically isolate a first portion of a waveguide from a second portion of the waveguide.

13. The waveguide separator according to claim 12, wherein at least the material of the second component is a nonconductive material to effect a potential separation of the first portion from the second portion.
